(19) United States
(12) Patent Application Publication
(10) Pub. No.: US 2014/0223544 A1
(43) Pub. Date: Aug. 7, 2014

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: Yosuke Yoshida, Yokohama-shi (JP)

(73) Assignee: CANON KABUSHIKI KAISHA, Tokyo (JP)

(21) Appl. No.: 14/169,316

(22) Filed: Jan. 31, 2014

(30) Foreign Application Priority Data
Feb. 5, 2013 (JP) 2013-020323

(51) Int. Cl. G06F 21/31

(52) U.S. Cl. CPC G06F 21/31
USPC 726/16

(57) ABSTRACT

When an input prediction function is used, a character string which a user does not want to display is prevented from being displayed as an input candidate while suppressing a load on the user.

### BACKGROUND OF THE INVENTION

1. Field of the Invention

The present invention relates to an information processing apparatus, a method for controlling an information processing apparatus, and a storage medium.

2. Description of the Related Art

Among existing information processing apparatuses such as a personal computer (PC) and a mobile phone, there exists an information processing apparatus provided with an input prediction function (refer to Japanese Patent Application Laid-Open No. 2001-243221).

Upon a user inputting a character, the input prediction function predicts a character string to be input following the input character based on an input history and displays a list of predicted character strings as input candidates. When the user selects a desired character string among the displayed input candidates, the selected character string is determined as the input character string. Thus, the user can complete input of a character string without inputting the entire character string.

The use of such a function, however, may disadvantageously display a character string which the user does not want to display as an input history, since the input history is displayed when the user inputs a character.

For example, if a user A has input a character string that relates to the user A's privacy such as the user A's name or address, or a character string that relates to confidential matters such as a code name of a product under development, such a character string is retained in the input history. When another user B inputs a character at a later time, the aforementioned character string is displayed as an input candidate, and thus information which the user A does not want others to see may be seen by the user B.

Meanwhile, to date, there exists a control method through which, upon a user selecting a clear button on a screen where a character string is to be input, a character string that has been input on the screen is not retained in the input history (refer to Japanese Patent Application Laid-Open No. 2009-104222). Japanese Patent Application Laid-Open No. 2009-104222 also discusses a method for deleting a character string, one by one, by selecting a desired character string from a list of character strings that have once been retained in the input history and also a method for deleting the input history at once.

There also exists a method in which a save function for saving an input history is disabled or a method in which a function of displaying a predicted character string as an input candidate is disabled.

These existing methods, however, have the following issues.

In the case of the method discussed in Japanese Patent Application Laid-Open No. 2009-104222, the user has to select the clear button each time the user inputs a character string. In particular, if a character string which the user does not want to retain in the input history is a character string which the user needs to input frequently, the user has to specify the clear button each time the user inputs that character string.

In the case of the method in which the user individually deletes a character string which the user wants to delete from the list of displayed input candidates as well, the user needs to delete the character string after each time the user inputs that character string, which increases a load on the user.

With the method in which the input history is deleted at once, character strings that the user does not want to delete are deleted as well, and thus a character string which the user wants to be displayed as an input candidate may not be displayed through the input prediction function, which hinders the user convenience.

Furthermore, the method in which the save function for saving the input history or the input prediction function is disabled does not allow the user to use the input prediction function, which also hinders the user convenience.

### SUMMARY OF THE INVENTION

The present invention is directed to an information processing apparatus.

According to an aspect of the present invention, an information processing apparatus includes a storage unit configured to store an input character string in an input history, a display unit configured to display a character string that follows a character input by a user as an input candidate based on the input history stored in the storage unit, a registration unit configured to register a predetermined character string, a control unit configured to control such that the predetermined character string registered in the registration unit is not displayed as the input candidate, a deletion unit configured to delete a character string from the input history stored in the storage unit, a retaining unit configured to retain a value corresponding to the number of times the character string has been deleted by the deletion unit, and a determination unit configured to determine whether the value retained by the retaining unit is equal to or greater than a predetermined value. In such an information processing apparatus, the registration unit registers the character string deleted by the deletion unit in a case in which the determination unit determines that the value retained by the retaining unit is equal to or greater than the predetermined value.

Further features of the present invention will become apparent from the following description of exemplary embodiments with reference to the attached drawings.

### BRIEF DESCRIPTION OF THE DRAWINGS

FIG. 1 illustrates an overview of a system according to an exemplary embodiment of the present invention.

FIG. 2 is a block diagram illustrating a hardware configuration of an information processing apparatus according to an exemplary embodiment of the present invention.

FIGS. 3A and 3B illustrate data to be stored in a storage area according to an exemplary embodiment of the present invention.

FIG. 4 is a flowchart illustrating a processing procedure according to an exemplary embodiment of the present invention.

FIG. 5 illustrates an operation screen according to an exemplary embodiment of the present invention.

FIG. 6 is a flowchart illustrating a processing procedure according to an exemplary embodiment of the present invention.

FIGS. 7A, 7B, 7C, and 7D each illustrate an operation screen according to an exemplary embodiment of the present invention.

FIG. 8 is a flowchart illustrating a processing procedure according to an exemplary embodiment of the present invention.

FIGS. 9A, 9B, and 9C each illustrate an operation screen according to an exemplary embodiment of the present invention.

FIG. 10 illustrates data to be stored in a storage area according to an exemplary embodiment of the present invention.

FIG. 11 is a flowchart illustrating a processing procedure according to an exemplary embodiment of the present invention.

FIGS. 12A and 12B illustrate data to be stored in a storage area according to an exemplary embodiment of the present invention.

FIGS. 13A, 13B, 13C, and 13D each illustrate an operation screen according to an exemplary embodiment of the present invention.

FIG. 14 is a flowchart illustrating a processing procedure according to an exemplary embodiment of the present invention.

### DESCRIPTION OF THE EMBODIMENTS

Various exemplary embodiments, features, and aspects of the invention will be described in detail below with reference to the drawings.

Hereinafter, a first exemplary embodiment will be described.

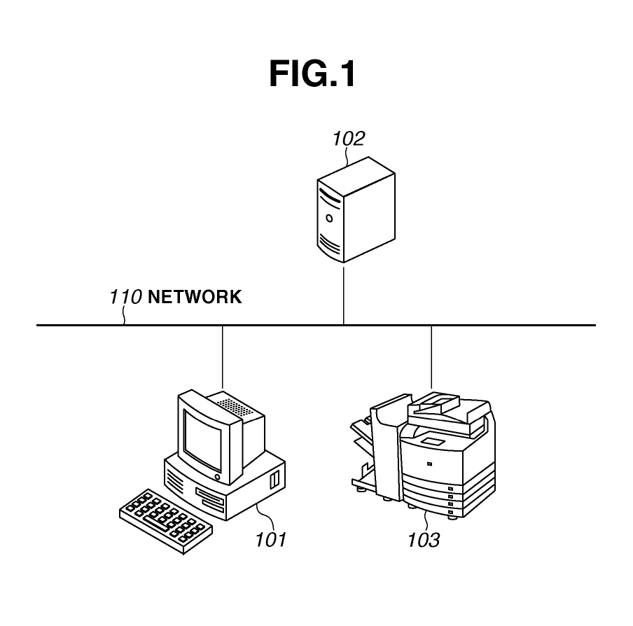

FIG. 1 illustrates an overview of a system that includes an information processing apparatus 101 of the first exemplary embodiment of the present invention. The system illustrated in FIG. 1 includes the information processing apparatus 101, a server 102, and a printer 103. The information processing apparatus 101, which is, for example, a PC, generates image data in accordance with a user operation or transmits a print instruction to the printer 103. The server 102, which stores web pages that can be browsed by the information processing apparatus 101, receives a keyword from the information processing apparatus 101 and returns a web page that corresponds to the received keyword to the information processing apparatus 101. The printer 103 includes a printing unit that prints an image on a sheet in accordance with image data, and upon receiving print data and a print instruction from the information processing apparatus 101, the printer 103 prints an image on a sheet based on the received print data. Here, the printer 103 may be a multifunction peripheral that includes, in addition to a print function of printing by receiving print data from the information processing apparatus 101, a copy function of reading an image on a document by a reading unit to generate image data and printing the image data. The information processing apparatus 101, the server 102, and the printer 103 communicate with one another through a network 110.

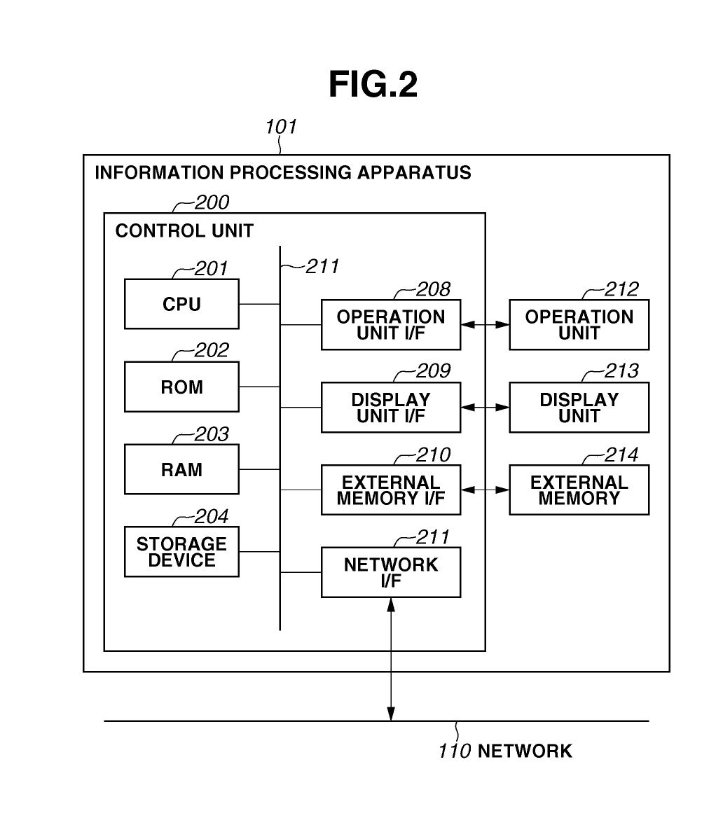

FIG. 2 is a block diagram illustrating a hardware configuration of the information processing apparatus 101 of the first exemplary embodiment of the present invention.

The information processing apparatus 101 includes a control unit 200, an operation unit 212, and a display unit 213. In addition, an external memory 214 can be connected to the information processing apparatus 101.

The control unit 200 controls the information processing apparatus 101 as a whole. The control unit 200 includes a central processing unit (CPU) 201, a read only memory (ROM) 202, a random access memory (RAM) 203, a storage device 204, an operation unit interface (I/F) 208, a display unit I/F 209, an external memory I/F 210, and a network I/F 211.

The CPU 201 loads a program stored in the ROM 202 or the storage device 204, and executes the program. The ROM 202 stores various programs to be loaded by the CPU 201. The RAM 203 functions as a work area for the CPU 201. The storage device 204 is a large-capacity memory such as a hard disk drive (HDD) and can store image data, a program, and so on.

The operation unit I/F 208 connects the operation unit 212 with the control unit 200. The operation unit 212 is formed by a keyboard and a mouse or by a touch panel sheet affixed to the display unit 213, and accepts a user operation. The keyboard can accept input of alphabets, symbols, and Hiragana characters, and input Hiragana characters can be converted into Chinese characters or Katakana characters. The operation unit I/F 208 relays an operation accepted through the operation unit 212 to the CPU 201.

The display unit I/F 209 connects the display unit 213 with the control unit 200. The display unit 213 is formed by a liquid crystal display or a cathode-ray tube (CRT) display, and displays an operation screen or a notification screen for notifying the user of the state of the information processing apparatus 101.

The external memory I/F 210 connects the external memory 214 with the control unit 200. The external memory 214 is, for example, a hard disk (HD), a Floppy® disk (FD), a compact Flash® memory.

The network I/F 211 connects the control unit 200 to the network 110. The network I/F 211 controls communication between the information processing apparatus 101 and an apparatus on the network 110.

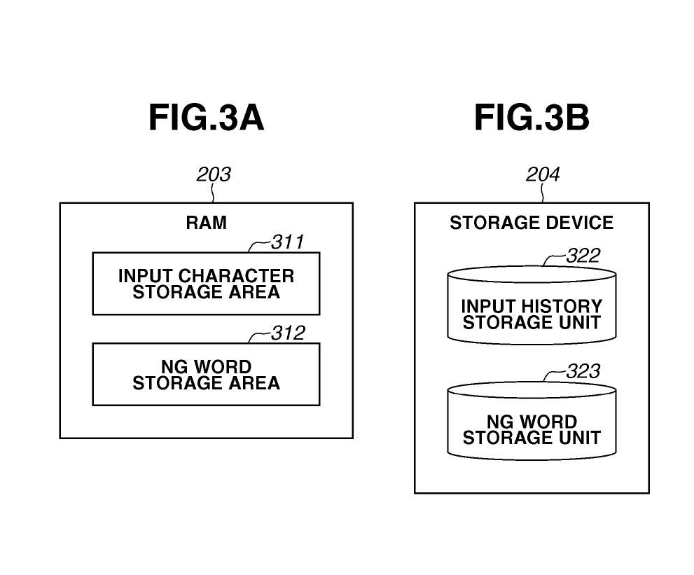

FIGS. 3A and 3B illustrate exemplary data to be stored in the RAM 203 and the storage device 204.

The RAM 203 illustrated in FIG. 3A includes an input character storage area 311 and an NG word storage area 312. Each of the input character storage area 311 and the NG word storage area 312 is used as a buffer for temporarily storing a character string input by the user until that character string is determined.

The storage device 204 illustrated in FIG. 3B includes an input history storage unit 322 and an NG word storage unit 323. Once a character string input by the user is determined, the input history storage unit 322 stores that character string as an input history. The character string stored in the input history storage unit 322 is then displayed as an input candidate when the user inputs a given character. The NG word storage unit 323 stores a character string which the user does not want to display as an input candidate (i.e., NG word).

The information processing apparatus 101 having such a configuration as described above operates as follows.

The information processing apparatus 101 is provided with an input prediction function, through which the information processing apparatus 101 predicts, upon the user inputting a character through the operation unit 212, a character string that follows the input character, and displays the predicted character string on the display unit 213. Such an input prediction function enables the user to input a desired character string by selecting a displayed character string without inputting the desired character string to the end.

For example, if a user A has ever input a character string that relates to the user A's privacy such as the user A's name or address, or a character string that relates to confidential matters such as a code name of a product under development, that character string is retained as the input history. If the same user A inputs a given character at a later time, displaying the character string which the user A has previously input through the input prediction can save the user A's time for inputting the character string. If, however, that character string is displayed as an input candidate when another user B inputs a given character as well, information which the user A does not want another user to see may be seen by the other user.

Accordingly, the information processing apparatus 101 of the first exemplary embodiment registers, in advance, a character string which the user does not want to display, and controls such that the character string which the user does not want to display is not displayed when displaying a character string that follows a character input by the user.

Hereinafter, such control will be described in detail.

First, processing for registering, in advance, a character string which the user does not want to display as an input candidate (i.e., NG word) will be described.

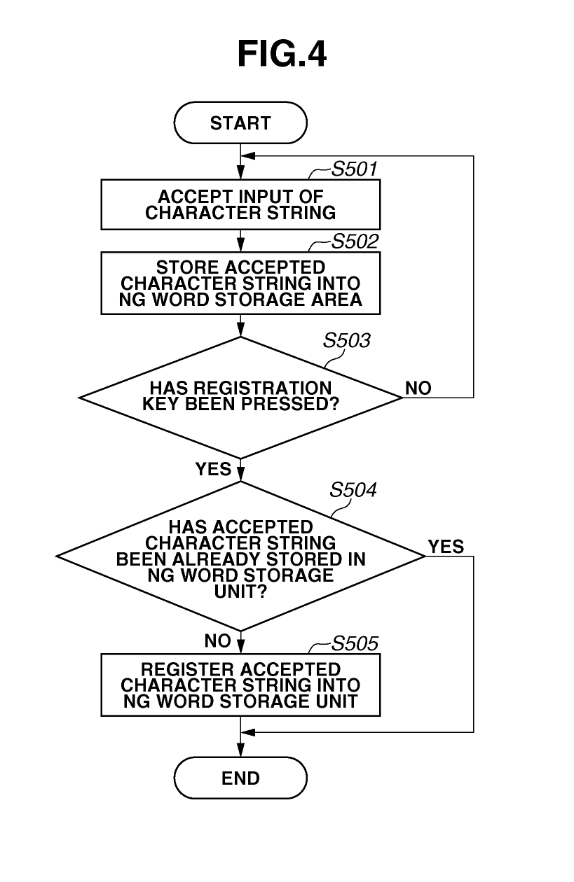

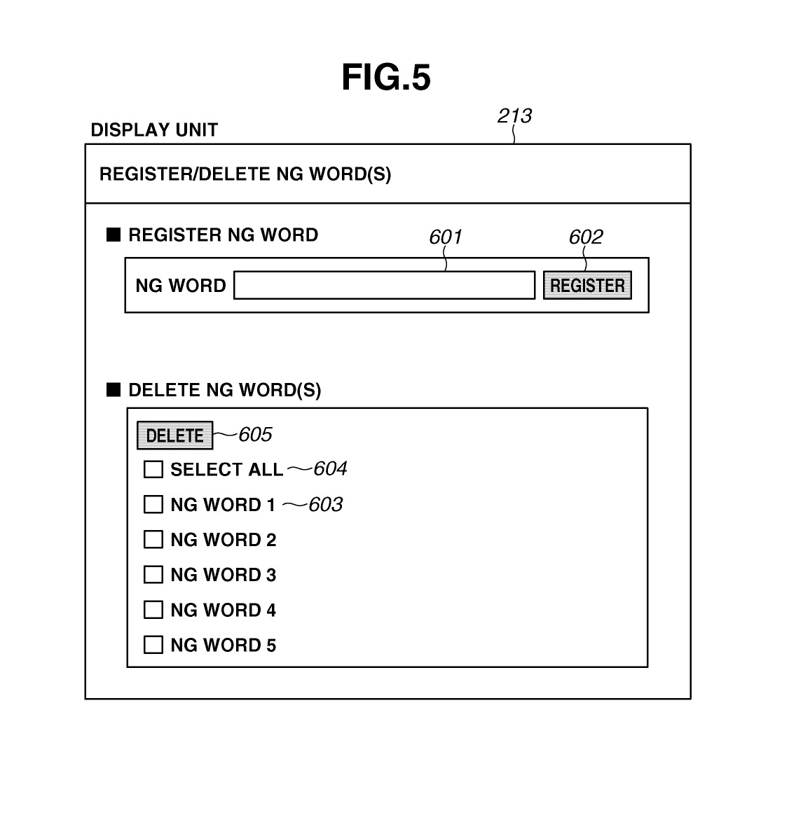

FIG. 4 is a flowchart for describing processing according to the first exemplary embodiment of the present invention. The processing indicated in the flowchart of FIG. 4 is implemented as the CPU 201 loads a program stored in the ROM 202 onto the RAM 203, and executes the program. Note that the processing indicated in the flowchart of FIG. 4 starts in a state in which a screen illustrated in FIG. 5 is displayed in the display unit 213.

In step S501, the CPU 201 accepts a character input by the user. An NG word input field 601 serves as a field in which the user inputs a character, and the user designates the NG word input field 601 to input a character through the operation unit 212. The CPU 201 displays the input character in the NG word input field 601. A registration button 602 serves as a button which allows the user to request the character string input in the NG word input field 601 to be registered as an NG word.

In step S502, the CPU 201 temporarily stores the character accepted in step S501 into the NG word storage area 312 of the RAM 203.

In step S503, the CPU 201 determines whether the user has pressed the registration button 602. If the CPU 201 determines that the user has pressed the registration button 602 (Yes in step S503), the CPU 201 proceeds to step S504. If the CPU 201 determines that the user has not pressed the registration button 602 (No in step S503), the CPU 201 returns to step S501.

In step S504, the CPU 201 determines whether the character string, which has been stored in the NG word storage area 312, has already been registered in the NG word storage unit 323. If the CPU 201 determines that the character string has already been registered in the NG word storage unit 323 (Yes in step S504), the CPU 201 terminates the processing indicated in FIG. 4. Meanwhile, if the CPU 201 determines that the character string has not been registered in the NG word storage unit 323 (No in step S504), the CPU 201 proceeds to step S505.

In step S505, the CPU 201 registers the character string, which has been input in the NG word input field 601, into the NG word storage unit 323 as an NG word, and then terminates the processing.

In this manner, the user can register an NG word which the user does not want to display as an input candidate into the NG word storage unit 323.

Note that the user can also delete an NG word that has once been registered. NG words that have already been registered are displayed as an NG word 1 to an NG word 5 in an NG word list 603 illustrated in FIG. 5. The user selects, from these NG words, an NG word which the user wants to delete by using a checkbox. Upon the user pressing a delete button 605 in the state in which the NG word has been selected, the CPU 201 deletes the NG word selected by the checkbox from the NG word storage unit 323.

For example, if the user selects a checkbox next to the “NG word 2” on the NG word list 603 and presses the delete button 605, the CPU 201 deletes a character string that corresponds to the “NG word 2” from the NG word storage unit 323. An item “delete all” 604 allows the user to select all of the NG words registered in the NG word storage unit 323 at once. If the user presses the delete button 605 in a state in which the checkbox next to “delete all” 604 has been selected, the CPU 201 deletes all of the NG words stored in the NG word storage unit 323.

Next, processing carried out when the user inputs a character string will be described.

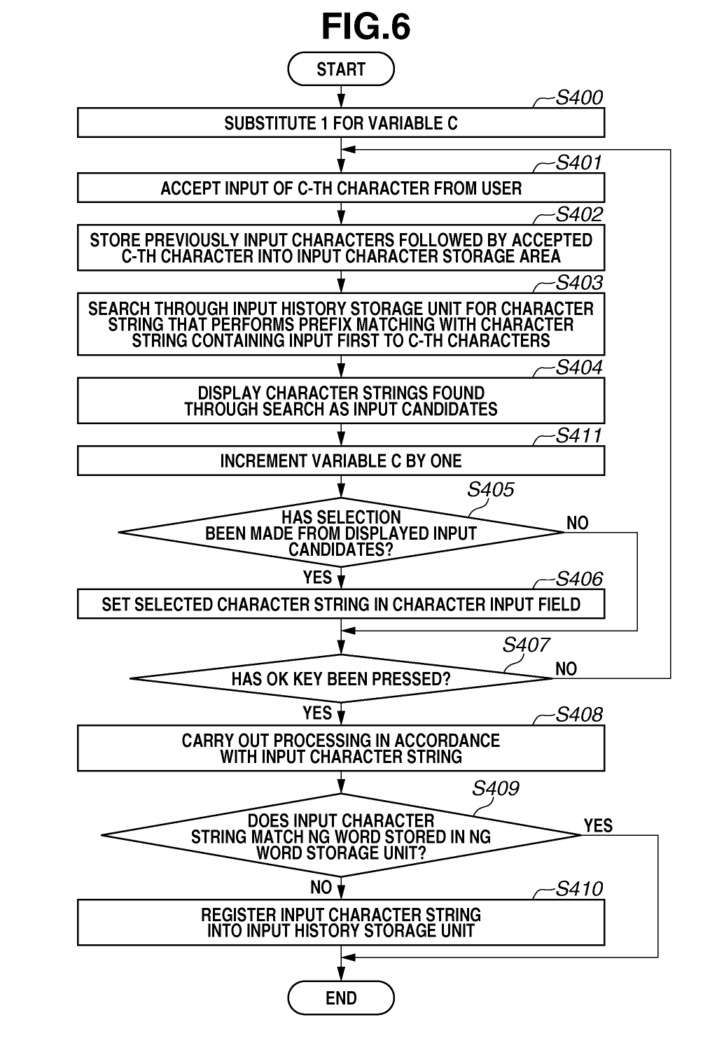

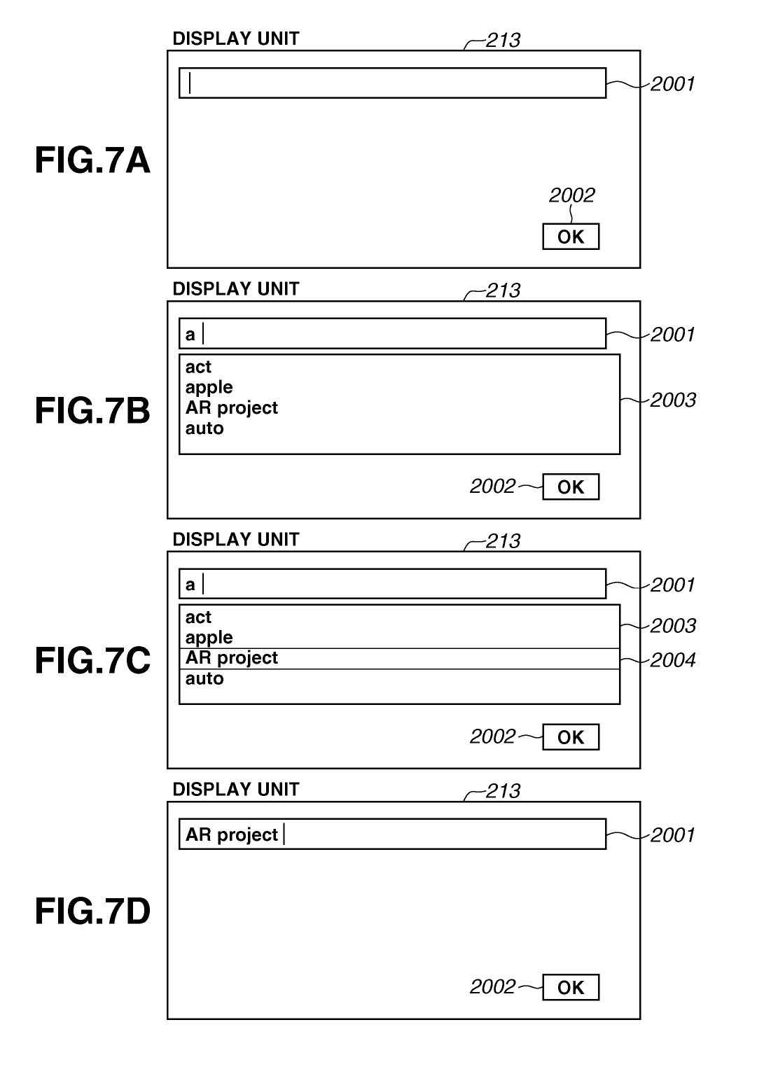

FIG. 6 is a flowchart for describing processing according to the first exemplary embodiment of the present invention. The processing indicated in the flowchart of FIG. 6 is implemented as the CPU 201 loads a program stored in the ROM 202 onto the RAM 203, and executes the program. Note that the processing indicated in the flowchart of FIG. 6 starts in a state in which a screen illustrated in FIG. 7A is displayed in the display unit 213.

In step S400, the CPU 201 prepares a variable C in the RAM 203 and substitutes an initial value 1 for the variable C.

In step S401, the CPU 201 accepts input of a C-th character from the user. The user inputs the character in a character input field 2001. The screen illustrated in FIG. 7A may be any screen as long as that screen accepts input of a keyword. For example, the screen may be a screen for inputting a search keyword in a browser provided in the information processing apparatus 101, or may be a screen for searching for a given word through a dictionary provided in the information processing apparatus 101. Alternatively, the aforementioned screen may be a screen for searching for a given address through an address book. Here, the aforementioned screen is not limited to a search screen, but may be a screen for inputting a schedule in a calendar or a screen for inputting a subject or a text of an e-mail message. Characters that can be input include Hiragana characters, Katakana characters, numerals, Chinese characters, alphabets, symbols, and so on.

In step S402, the CPU 201 stores previously input characters followed by the accepted C-th character into the input character storage area 311.

In step S403, the CPU 201 searches through the input history storage unit 322 for a character string that has a prefix match with the character string containing the input first to C-th characters. For example, if “a” has been input as the first character, the CPU 201 searches through the input history storage unit 322 for a character string that starts with “a”. Meanwhile, if “a” has been input as the first character and “u” has been input as the second character, the CPU 201 searches for a character string that starts with “au”. With regard to a character string that contains a Chinese character or an alphabet in the input history storage unit 322, the reading of the Chinese character or the alphabet is managed in Hiragana characters, and the CPU 201 searches for the character string by referring to the Hiragana characters.

In step S404, the CPU 201 displays a list of character strings that have been found through the search as input candidates in the display unit 213. The screen illustrated in FIG. 7B, for example, is displayed.

In step S411, the CPU 201 increments the variable C by 1 in case the user inputs a subsequent character.

In step S405, the CPU 201 determines whether the user has selected one from the list of displayed input candidates. If the CPU 201 determines that the use has made a selection (Yes in step S405), the CPU 201 proceeds to step S406.

In step S406, the CPU 201 sets the selected character string in the character input field 2001. The selected character string is thus displayed in the character input field 2001. The screen illustrated in FIG. 7C indicates that the character string “AR project” has been selected, and the screen illustrated in FIG. 7D indicates that the selected character string “AR project” has been displayed in the character input field 2001.

Meanwhile, if, in step S405, the CPU 201 determines that the user has not made a selection (No in step S405), the CPU 201 proceeds to step S407 without carrying out the processing in step S406.

In step S407, the CPU 201 determines whether the user has pressed an OK button 2002. The OK button 2002 serves as a button which allows the user to request the character string displayed in the character input field 2001 to be set as a determined character string. If the CPU 201 determines that the user has pressed the OK button 2002 (Yes in step S407), the CPU 201 proceeds to step S408. Meanwhile, if the CPU 201 determines that the user has not pressed the OK button 2002 (No in step S407), the CPU 201 returns to step S401.

In step S408, the CPU 201 carries out processing in accordance with the input character string. Specifically, the processing refers to a search through a website by the character string, a search for an address through an address book, registration of the character string into a schedule book or into a subject or a text of an e-mail message.

In step S409, the CPU 201 determines whether the character string that has been set as the determined character string by the user pressing the OK button 2002 in step S407 matches an NG word stored in the NG word storage unit 323. If the CPU 201 determines that there is no match (No in step S409), the CPU 201 proceeds to step S410. If the CPU 201 determines that there is a match (Yes in step S409), the CPU 201 terminates the processing without carrying out processing in step S410.

In step S410, the CPU 201 stores the character string that has been set as the determined character string into the input history storage unit 322, and then terminates the processing.

Such control as described above can prevent a character string that has been registered in advance as a character string which the user does not want to display as an input candidate from being stored as the input history. This in turn can prevent the character string, which the user does not want to display as an input candidate, from being displayed as an input candidate, when the user inputs a given character in a subsequent occasion. Meanwhile, a character string other than a character string which the user does not want to display as an input candidate can be displayed as an input candidate when the user inputs a given character in a subsequent occasion.

In this manner, the first exemplary embodiment of the present invention can prevent a character string which the user does not want a third party to see from being displayed through the input prediction function, while retaining the convenience of the input prediction function and suppressing a load on the user.

In the first exemplary embodiment, an example in which the CPU 201 controls such that a character string that is equivalent to a character string stored in the NG word storage unit 323 is prevented from being stored in the input history storage unit 322 has been described. An exemplary embodiment of the present invention, however, is not limited thereto. The CPU 201 may, for example, control as follows. For example, the CPU 201 stores, into the input history storage unit 322, even a character string that is equivalent to a character string stored in the NG word storage unit 323. However, prior to displaying a character string stored in the input history storage unit 322 as an input candidate, if a character string to be displayed matches a character string stored in the NG word storage unit 323, the CPU 201 controls such that that character string is prevented from being displayed as an input candidate.

In the first exemplary embodiment, an example in which the CPU 201 determines, in step S409, whether the character string that has been set as the determined character string matches an NG word stored in the NG word storage unit 323 has been described. An exemplary embodiment of the present invention, however, is not limited thereto. For example, the CPU 201 may determine whether the character string that has been set as the determined character string contains an NG word. An example in which a word “camera” has been registered in advance as an NG word will be described. When the user inputs a character string “video camera”, the CPU 201 may control such that the character string “video camera” is prevented from being stored in the input history storage unit 322 since that character string set as the determined character string contains the aforementioned NG word.

Although only a case in which the user inputs a character in step S401 has been described in the example above, if the user deletes a character that has once been input in step S401, the CPU 201 may delete the C-th character in the character string that has been stored in the input character storage area 311, and may decrement the variable C by 1 in step S411.

Although an example in which the storage device 204 illustrated in FIG. 3B is included in the information processing apparatus 101 has been described, the server 102 may include the storage device 204. In that case, the information processing apparatus 101 cooperates with the server 102 to carry out the control described above.

Specifically, as the processing for registering, in advance, a character string which the user does not want to display as an input candidate (i.e., NG word), the information processing apparatus 101 first carries out the processes in steps S501 to S503 of FIG. 4. If, in step S503, the CPU 201 determines that the user has pressed the registration button 602 (Yes in step S503), the CPU 201 transmits a request for registration of the NG word to the server 102. In step S504, a CPU of the server 102 determines whether the NG word that has been requested to be registered has already been registered in an NG word storage unit 323 of the server 102. If the CPU of the server 102 determines that the NG word has not been registered (No in step S504), the CPU of the server 102 registers the character string that has been requested to be registered as an NG word into the NG word storage unit 323 of the server 102 and then terminates the processing. Meanwhile, if the NG word that has been requested to be registered has already been registered in the NG word storage unit 323 of the server 102 (Yes in step S504), the CPU of the server 102 terminates the processing without carrying out the processing in step S505.

Thereafter, as the processing carried out when the user inputs a character string, the information processing apparatus 101 carries out the processes in steps S400 and S401 of FIG. 6. In step S402, the information processing apparatus 101 transmits the character string containing the first to C-th characters that has been stored in the input character storage area 311 to the server 102. In step S403, the server 102 searches through an input history storage unit 322 of the server 102 for a character string that has a prefix match with the character string containing the first to C-th characters that has been transmitted from the information processing apparatus 101. The server 102 then transmits an input candidate found through the search to the information processing apparatus 101, and in step S404, the information processing apparatus 101 displays the received input candidate in the display unit 213 and, in step S411, increments the variable C by 1. Thereafter, if, in step S405, the CPU 201 of the information processing apparatus 101 determines that the user has selected a character string from the displayed list (Yes in step S405), the CPU 201 notifies the server 102 of the selected character string. In response to this notification, in step S406, the server 102 sets the selected character string as the input character string. In step S407, the CPU 201 of the information processing apparatus 101 determines whether the user has pressed the OK button 2002. If the CPU 201 determines that the user has pressed the OK button 2002 (Yes in step S407), the CPU 201 notifies the server 102 that the user has pressed the OK button 2002. Upon receiving this notification, in step S408, the CPU of the server 102 carries out processing in accordance with the input character string. In step S409, the CPU of the server 102 determines whether the character string set in step S406 has been registered in the NG word storage unit 323. If the character string has not been registered in the NG word storage unit 323 (No in step S409), in step S410, the CPU of the server 102 stores the input character string into the input history storage unit 322, and then terminates the processing. Meanwhile, if the character string set in step S406 has been registered in the NG word storage unit 323 (Yes in step S409), the CPU of the server 102 terminates the processing without storing the input character string into the input history storage unit 322.

Hereinafter, a second exemplary embodiment of the present invention will be described.

In the second exemplary embodiment, a case in which the user can delete a given character string selected from a list of input candidates, which is displayed while the user inputs a character, and the deleted character string is automatically registered into the NG word storage unit 323 will be described. With this configuration, as the user deletes a character string which the user does not want to display as an input candidate, that character string can be prevented from being displayed as an input candidate at a later time.

Note that the system configuration described with reference to FIG. 1, the configuration of the information processing apparatus 101 described with reference to FIG. 2, and the data to be stored in the RAM 203 and the storage device 204 described with reference to FIGS. 3A and 3B in the first exemplary embodiment are similar to those in the second exemplary embodiment. Thus, detailed descriptions thereof will be omitted, and configurations that differ from those of the first exemplary embodiment will be described, hereinafter.

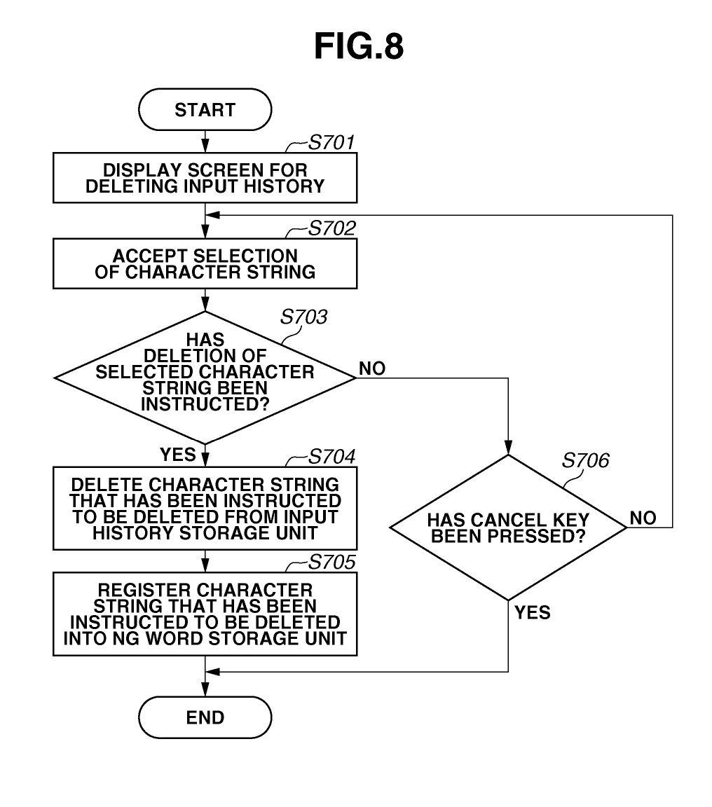

FIG. 8 is a flowchart for describing processing according to the second exemplary embodiment of the present invention. The processing indicated in the flowchart of FIG. 8 is implemented as the CPU 201 loads a program stored in the ROM 202 onto the RAM 203, and executes the program. The processing indicated in the flowchart of FIG. 8 starts in response to an instruction for deleting an input history.

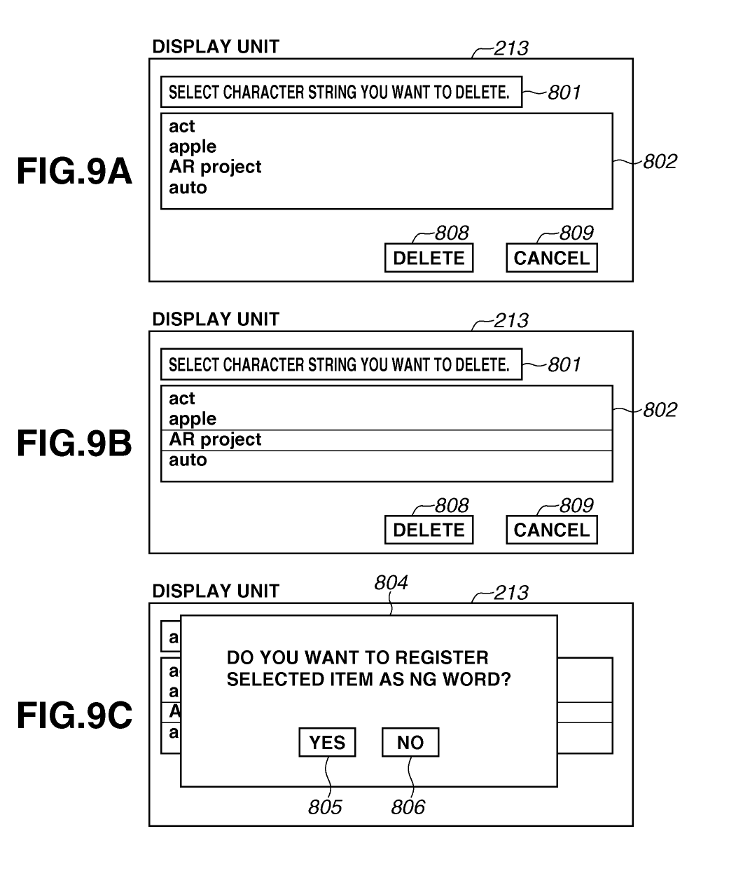

In step S701, the CPU 201 displays a screen for deleting an input history as illustrated in FIG. 9A. Displayed in the screen illustrated in FIG. 9A are a title 801, an input history list 802, a delete button 808, and a cancel button 809.

In step S702, the CPU 201 accepts selection of a character string through the operation unit 212. Upon the user selecting a character string, the CPU 201 displays, in the display unit 213, a screen indicating that the character string has been selected. In the screen illustrated in FIG. 9B, “AR project” has been selected.

In step S703, the CPU 201 determines whether the user has instructed the selected character string to be deleted. The instruction for deleting the character string is issued by the user pressing the delete button 808. If the CPU 201 determines that the user has instructed the character string to be deleted (Yes in step S703), the CPU 201 proceeds to step S704. Meanwhile, if the CPU 201 determines that the user has not instructed the character string to be deleted (No in step S703), the CPU 201 proceeds to step S706.

In step S704, the CPU 201 deletes the character string selected through the screen illustrated in FIG. 9A from the input history storage unit 322.

In step S705, the CPU 201 stores the character string selected through the screen illustrated in FIG. 9A into the NG word storage unit 323 so that such character string is not stored in the input history storage unit 322 as an input history at a later time. The CPU 201 then terminates the processing.

On the other hand, when the CPU 201 has proceeded from step S703 to step S706, in step S706, the CPU 201 determines whether the user has pressed the cancel button 809. If the CPU 201 determines that the user has pressed the cancel button 809 (Yes in step S706), the CPU 201 terminates the processing indicated in FIG. 8. Meanwhile, if the CPU 201 determines that the user has not pressed the cancel button 809 (No in step S706), the CPU 201 returns to step S702.

In this manner, according to the second exemplary embodiment, as the user goes through an operation for deleting a character string which the user does not want to display as an input candidate, that character string can be prevented from being displayed as an input candidate at a later time.

Although an example in which a character string that has been instructed to be deleted is always stored in the NG word storage unit 323 has been described in the second exemplary embodiment. An exemplary embodiment of the present invention, however, is not limited thereto. The CPU 201 may display a screen illustrated in FIG. 9C when the user has instructed a character string to be deleted, and may inquire of the user whether to store that character string, which has been instructed to be deleted, into the NG word storage unit 323. The CPU 201 may then control as follows. If the user selects “YES” through the screen illustrated in FIG. 9C, the CPU 201 stores the character string that has been instructed to be deleted into the NG word storage unit 323. If the user selects “NO”, the CPU 201 does not store the character string that has been instructed to be deleted into the NG word storage unit 323.

In the second exemplary embodiment, processing for registering a character string that has been instructed to be deleted once into the NG word storage unit 323 has been described.

In a third exemplary embodiment, processing for registering a character string into the NG word storage unit 323 if that character string has been deleted a predetermined number of times will be described.

Hereinafter, only configurations that differ from those of the second exemplary embodiment will be described.

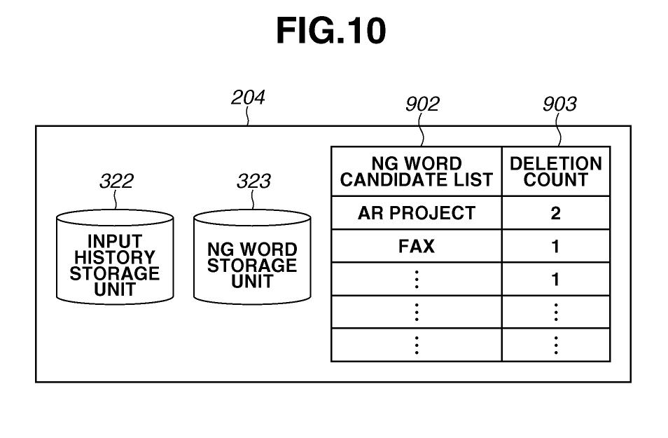

FIG. 10 illustrates exemplary data to be stored in the storage device 204 in the third exemplary embodiment.

The storage device 204 in the third exemplary embodiment includes the input history storage unit 322, the NG word storage unit 323, an NG word candidate list 902, and a deletion count 903.

The NG word storage unit 323 stores a character string that is not allowed to be saved in the input history storage unit 322 (i.e., NG word).

The NG word candidate list 902 indicates a character string that has ever been deleted from an input history. The deletion count 903 indicates the number of times each character string has been deleted.

The example illustrated in FIG. 10 indicates that the character string “AR project” saved in the NG word candidate list 902 has been deleted the number of times indicated in the deletion count 903 (i.e., twice). In other words, there is a strong possibility that the character string “AR project” is a character string which the user does not want to display as an input candidate. Thus, in the third exemplary embodiment, when an identical character string has been deleted a predetermined number of times, the CPU 201 controls such that that character string is automatically registered into the NG word storage unit 323 so that that character string is not displayed as an input candidate.

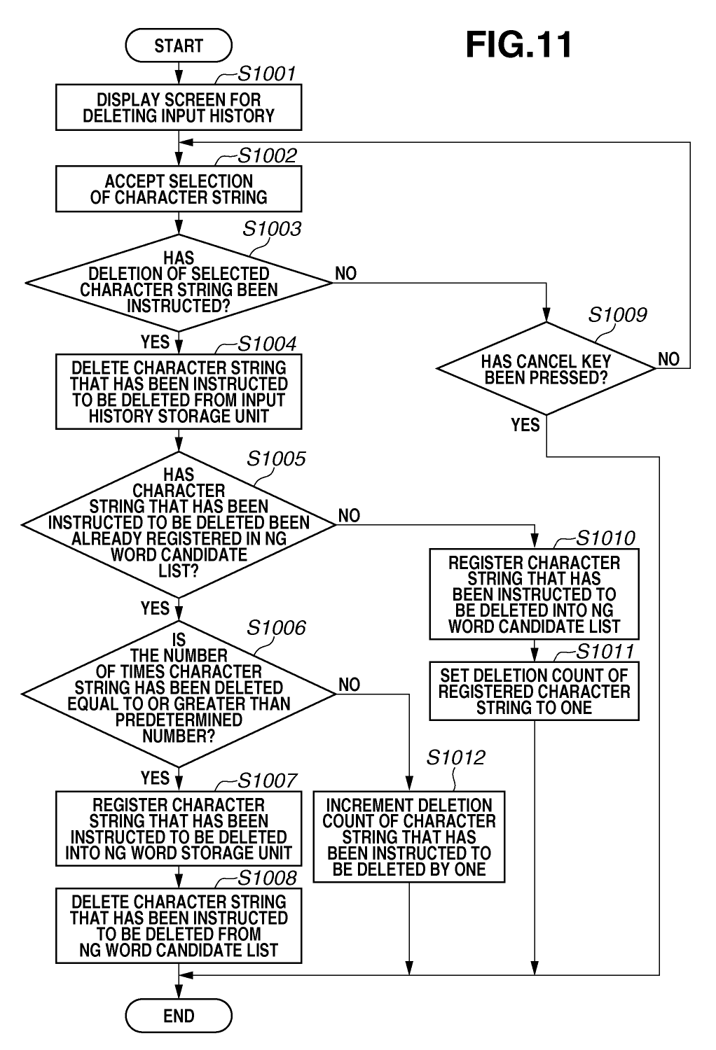

FIG. 11 is a flowchart for describing a series of processes through which the information processing apparatus 101 stores, into the NG word storage unit 323, a character string which the user has deleted from the input history N times through the operation unit 212. Each of the operations illustrated in FIG. 11 is realized as the CPU 201 loads a control program stored in the ROM 202 or the storage device 204, and executes the control program. The processing indicated in the flowchart of FIG. 11 starts in response to an instruction for deleting an input history.

In step S1001, the CPU 201 displays the screen for deleting an input history as illustrated in FIG. 9A. Displayed in the screen illustrated in FIG. 9A are the title 801, the input history list 802, the delete button 808, and the cancel button 809.

In step S1002, the CPU 201 accepts selection of a character string through the operation unit 212. Upon the user selecting a character string, the CPU 201 displays, in the display unit 213, a screen indicating that the character string has been selected. The screen illustrated in FIG. 9B indicates an example in which “AR project” has been selected.

In step S1003, the CPU 201 determines whether the user has instructed the selected character string to be deleted. The instruction for deleting the character string is issued by the user pressing the delete button 808. If the CPU 201 determines that the user has instructed the character string to be deleted (Yes in step S1003), the CPU 201 proceeds to step S1004. Meanwhile, if the CPU 201 determines that the user has not instructed the character string to be deleted (No in step S1003), the CPU 201 proceeds to step S1009.

In step S1004, the CPU 201 deletes the character string selected through the screen illustrated in FIG. 9A from the input history storage unit 322.

In step S1005, the CPU 201 determines whether the character string that has been instructed to be deleted has already been registered in the NG word candidate list 902. If the CPU 201 determines that the character string has already been registered in the NG word candidate list 902 (Yes in step S1005), the CPU 201 proceeds to step S1006. Meanwhile, if the CPU 201 determines that the character string has not been registered in the NG word candidate list 902 (No in step S1005), the CPU 201 proceeds to step S1010.

In step S1006, the CPU 201 determines whether the number of times the character string has been deleted is equal to or greater than a predetermined number of times. A value for this predetermined number of times may be a preset fixed value. Alternatively, the user may be allowed to modify the value by an instructing through the operation unit 212. If the CPU 201 determines that the number of times the character string has been deleted is equal to or greater than the predetermined number of times (Yes in step S1006), the CPU 201 proceeds to step S1007. Meanwhile, if the CPU 201 determines that the number of times the character string has been deleted is less than the predetermined number of times (No in step S1006), the CPU 201 proceeds to step S1012.

In step S1007, the CPU 201 registers the character string that has been instructed to be deleted into an NG word list of the NG word storage unit 323 so that that character string is not stored in the input history storage unit 322 as an input history at a later time.

In step S1008, the CPU 201 deletes the character string that has been instructed to be deleted from the NG word candidate list 902. Here, the CPU 201 also clears the deletion count 903 of the character string that has been instructed to be deleted. The CPU 201 then terminates the processing indicated in the flowchart of FIG. 11.

On the other hand, when the CPU 201 has proceeded from step S1003 to step S1009, in step S1009, the CPU 201 determines whether the user has pressed the cancel button 809 through the screen illustrated in FIG. 9A. If the CPU 201 determines that the user has pressed the cancel button 809 (Yes in step S1009), the CPU 201 terminates the processing indicated in the flowchart of FIG. 11. Meanwhile, if the CPU 201 determines that the user has not pressed the cancel button 809 (No in step S1009), the CPU 201 returns to step S1002.

When the CPU 201 has proceeded from step S1005 to step S1010, in step S1010, the CPU 201 newly registers the character string that has been instructed to be deleted into the NG word candidate list 902 of the NG word storage unit 323.

In step S1011, the CPU 201 sets the deletion count 903 of the character string that has been newly registered in step S1010 to 1, and then terminates the processing indicated in the flowchart of FIG. 11.

When the CPU 201 has proceeded from step S1006 to step S1012, in step S1012, the CPU 201 increments the deletion count 903 of the character string that has been instructed to be deleted by 1, and then terminates the processing indicated in the flowchart of FIG. 11.

Through such control as described above, when an identical character string has been deleted a predetermined number of times, the CPU 201 registers that character string into the NG word storage unit 323 as an NG word so that such character string is not displayed as an input candidate.

Although an example in which a character string that has been instructed to be deleted a predetermined number of times is always stored in the NG word storage unit 323 has been described in the third exemplary embodiment. An exemplary embodiment of the present invention, however, is not limited thereto. The CPU 201 may display the screen illustrated in FIG. 9C when the user has instructed a character string to be deleted a predetermined number of times, and may inquire of the user whether to store the character string which has been instructed to be deleted into the NG word storage unit 323. If the user selects “YES” through the screen illustrated in FIG. 9C, the CPU 201 stores the character string that has been instructed to be deleted into the NG word list of the NG word storage unit 323. Meanwhile, if the user selects “NO”, the CPU 201 does not register the character string that has been instructed to be deleted into the NG word list of the NG word storage unit 323.

In the exemplary embodiment above, an example in which, if the user inputs a character string that contains a character string which has been registered in advance, the input character string is prevented from being retained in the input history has been described.

A character string which the user does not want to retain, however, may not be limited to a character string which the user has registered in advance. For example, if the user presses an OK button in a state in which the user has failed to input a character string correctly, an incorrect character string is retained as an input history. In that case, the incorrect character string is displayed as an input prediction candidate when the user inputs a given character at a subsequent time, which causes the user trouble in selecting a character string which the user wants to input.

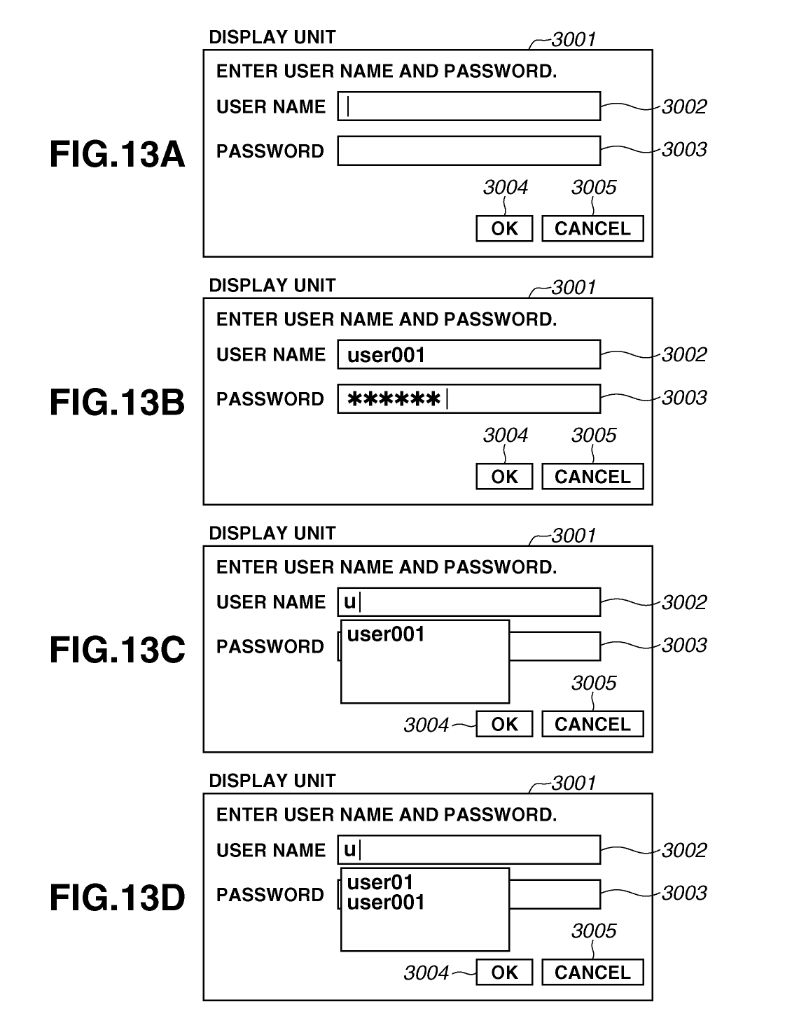

For example, when, in an authentication information input screen illustrated in FIG. 13A, the user inputs a user name “user001”, presses the Enter key, inputs a password, and then presses the Enter key, a screen illustrated in FIG. 13B is displayed. Then, upon the user pressing an OK button 3004, user authentication starts. Here, when the user inputs the user name “user001” and then presses the Enter key, the information processing apparatus 101 retains “user001” as the input history. Through this, the information processing apparatus 101 can display the character string “user001” as illustrated in FIG. 13C at a later time upon the user inputting the first character “u” of the user name to assist the user in inputting the user name. The user then selects the displayed “user001”, and thus the user can set the character string “user001” in the user name.

If, however, the user incorrectly inputs “user01” and presses a confirm key, an existing information processing apparatus retains “user01” as the input history. Thus, when the user inputs the first character “u”, the character strings “user001” and “user01” are both displayed as input candidates as illustrated in FIG. 13D. As a result, the user has to be careful in selecting “user001”, which increases an operation load on the user.

Accordingly, in an exemplary embodiment, such control is carried out that even a character string which the user has input is not retained in the input history if there is a strong possibility that the user has input that character string incorrectly.

Hereinafter, such control will be described in detail.

Note that the system configuration described with reference to FIG. 1 and the configuration of the information processing apparatus 101 described with reference to FIG. 2 in the first exemplary embodiment are similar in the exemplary embodiment. Thus, detailed descriptions thereof will be omitted, and configurations that differ from those of the first exemplary embodiment will be described, hereinafter.

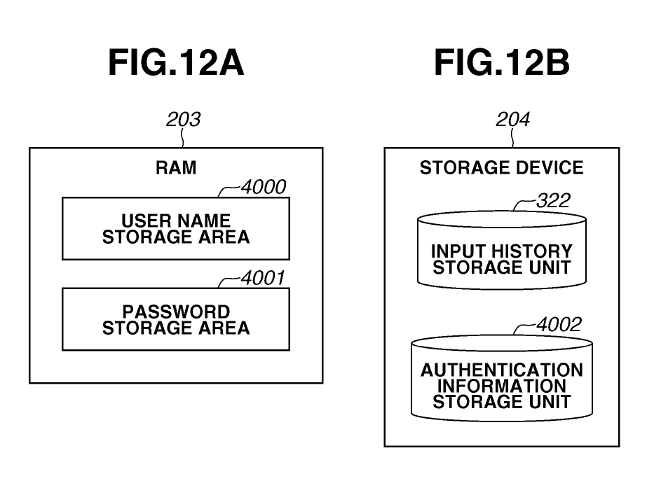

FIGS. 12A and 12B illustrate exemplary data to be stored in the RAM 203 and the storage device 204, respectively.

The RAM 203 illustrated in FIG. 12A includes a user name storage area 4000 and a password storage area 4001. The user name storage area 4000 is used as a buffer for temporarily storing a character string for a user name input by the user until that character string is determined. The password storage area 4001 is used as a buffer for temporarily storing a character string for a password input by the user until that character string is determined.

The storage device 204 illustrated in FIG. 12B includes the input history storage unit 322 and an authentication information storage unit 4002. The input history storage unit 322 stores a character string that has been determined to be retained as the input history. A character string stored in the input history storage unit 322 is displayed as an input candidate when the user inputs a given character. The authentication information storage unit 4002 stores a set of a user name and a password on a user-by-user basis. The user name and the password are used to authenticate the user.

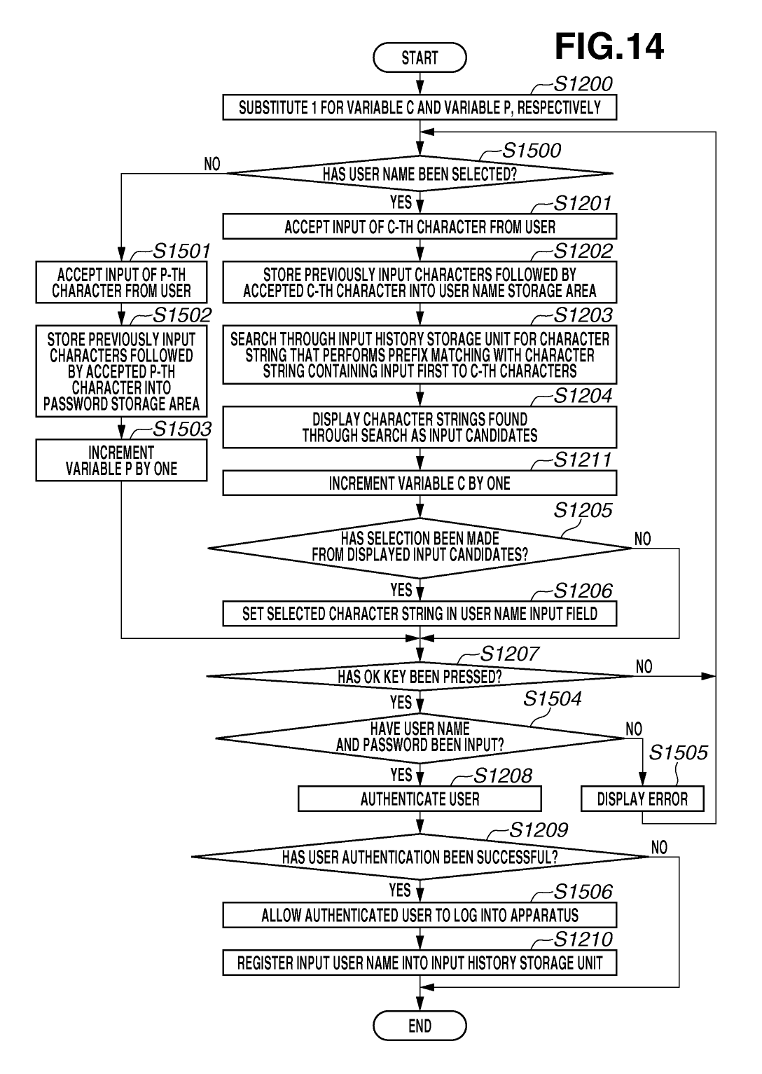

FIG. 14 is a flowchart for describing processing according to a fourth exemplary embodiment of the present invention. The processing indicated in the flowchart of FIG. 14 is implemented as the CPU 201 loads a program stored in the ROM 202 onto the RAM 203 and executes the program. Note that the processing indicated in the flowchart of FIG. 14 starts in a state in which the authentication information input screen illustrated in FIG. 13A is displayed in the display unit 213.

In step S1200, the CPU 201 prepares a variable C and a variable P in the RAM 203, and substitutes an initial value 1 for each of the variable C and the variable P.

In step S1500, the CPU 201 determines whether the user has selected the user name or the password through the screen illustrated in FIG. 13A by using the operation unit 212 of the information processing apparatus 101. If the CPU 201 determines that the user has selected the user name (Yes in step S1500), the CPU 201 proceeds to step S1201. If the CPU 201 determines that the user has selected the password (No in step S1500), the CPU 201 proceeds to step S1501.

When the CPU 201 has proceeded to step S1201, in step S1201, the CPU 201 accepts input of a C-th character from the user. The user inputs the character in a user name input field 3002.

In step S1202, the CPU 201 stores previously input characters followed by the accepted C-th character into the user name storage area 4000.

In step S1203, the CPU 201 searches through the input history storage unit 322 for a character string that has a prefix match with the character string containing the input first to C-th characters. For example, if “u” has been input as the first character, the CPU 201 searches through the input history storage unit 322 for a character string that starts with “u”. Meanwhile, if “u” has been input as the first character and “s” has been input as the second character, the CPU 201 searches for a character string that starts with “us”.

In step S1204, the CPU 201 displays a list of character strings found through the search as input candidates in the display unit 213. The screen illustrated in FIG. 13C, for example, is displayed.

In step S1211, the CPU 201 increments the variable C by 1 in case the user inputs a subsequent character.

In step S1205, the CPU 201 determines whether the user has selected a character string from the displayed list of the input candidates. If the CPU 201 determines that the user has made a selection (Yes in step S1205), the CPU 201 proceeds to step S1206.

In step S1206, the CPU 201 sets the selected character string in the user name input field 3002. The set character string is thus displayed in the user name input field 3002. FIG. 13B indicates that the user name “user001” has been selected and that the selected character string “user001” has been displayed in the user name input field 3002.

On the other hand, if, in step S1205, the CPU 201 determines that the user has not made a selection (No in step S1205), the CPU 201 proceeds to step S1207 without carrying out the processing in step S1206.

In step S1207, the CPU 201 determines whether the user has pressed the OK button 3004. The user presses the OK button 3004 to start user authentication by using the user name input in the user name input field 3002 and the password input in a password input field 3003. If the CPU 201 determines that the user has pressed the OK button 3004 (Yes in step S1207), the CPU 201 proceeds to step S1504. Meanwhile, if the CPU 201 determines that the user has not pressed the OK button 3004 (No in step S1207), the CPU 201 returns to step S1500.

When the CPU 201 has proceeded from step S1500 to step S1501, in step S1501, the CPU 201 accepts input of a P-th character from the user. The user inputs the character in the password input field 3003.

In step S1502, the CPU 201 stores previously input characters followed by the accepted P-th character into the password storage area 4001.

In step S1503, the CPU 201 increments the variable P by 1 in case the user inputs a subsequent character. The CPU 201 then proceeds to step S1207.

When the CPU 201 has proceeded from step S1207 to step S1504, in step S1504, the CPU 201 determines whether the user has input the user name and the password in the user name input field 3002 and the password input field 3003, respectively. If the CPU 201 determines that the user has not input at least one of the user name and the password (No in step S1504), the CPU 201 proceeds to step S1505. Meanwhile, if the CPU 201 determines that the user has input both the user name and the password (Yes in step S1504), the CPU 201 proceeds to step S1208.

When the CPU 201 has proceeded to step S1505, in step S1505, the CPU 201 displays an error message in the display unit 213 and then returns to step S1500.

When the CPU 201 has proceeded to step S1208, in step S1208, the CPU 201 authenticates the user based on the user name input in the user name input field 3002 and the password input in the password input field 3003. Specifically, the CPU 201 determines whether the user name input in the user name input field 3002 and the password input in the password input field 3003 are registered in the authentication information storage unit 4002. If the user name and the password are registered in the authentication information storage unit 4002, the authentication succeeds. If at least one of the user name and the password is not registered in the authentication information storage unit 4002, the authentication fails.

In step S1209, the CPU 201 determines whether the user authentication has been successful. If the CPU 201 determines that the user authentication has been successful (Yes in step S1209), the CPU 201 proceeds to step S1506.

In step S1506, the CPU 201 allows the authenticated user to log into the information processing apparatus 101. The user who has logged into the information processing apparatus 101 is allowed to use an application in the information processing apparatus 101 until the user logs out.

In step S1210, the CPU 201 stores the input user name into the input history storage unit 322 so that the user name appears as an input prediction character string next time the user is to input the user name, and then terminates the processing.

On the other hand, if, in step S1209, the CPU 201 determines that the user authentication has not been successful (No in step S1209), the CPU 201 terminates the processing without carrying out the processes in steps S1506 and S1210.

Such control as described above can prevent a situation in which a character string that is likely to have been input incorrectly by the user is stored as the input history and is displayed as an input candidate next time the user inputs a given character. Meanwhile, the character string input by the user at an instance where the user authentication has been successful is likely to have been input correctly by the user, and thus that character string can be retained as the input history and displayed as an input candidate next time the user inputs a given character.

In this manner, the fourth exemplary embodiment of the present invention can prevent a character string which the user does not want to display from being displayed through the input prediction function, while retaining the convenience of the input prediction function and suppressing a load on the user for individually deleting the input history.

Note that an example of the processing carried out when the user logs into the information processing apparatus 101 has been described in the fourth exemplary embodiment. Thus, an example in which the information processing apparatus 101 includes the authentication information storage unit 4002 and the information processing apparatus 101 authenticates the user has been described. An exemplary embodiment of the present invention, however, can also be applied to processing carried out when the user logs into the server 102 by using a web browser provided in the information processing apparatus 101.

Although only a case in which the user inputs a character in step S1201 has been described above as an example, if the user deletes a character, in step S1201, that has once been input, the CPU 201 may delete the C-th character in the character string that has already been stored in the user name storage area 4000 and decrement the variable C by 1 in step S1211.

In addition, although only a case in which the user inputs a character in step S1501 has been described above as an example, if the user deletes a character, in step S1501, that has once been input, the CPU 201 may delete the P-th character in the character string that has already been stored in the password storage area 4001 and decrement the variable P by 1 in step S1503.

An example in which, if the user authentication based on the input character string (user name) has failed, the input character string (user name) is controlled not to be registered in the input history storage unit 322 has been described in the fourth exemplary embodiment. The exemplary embodiment of the present invention, however, is not limited thereto. When a character string (user name) that has once succeeded in user authentication and has been stored in the input history storage unit 322 fails to be authenticated, that character string may be deleted from the input history storage unit 322. This can suppress security degradation caused by a character string stored in the input history storage unit 322 being used blindly.

Although an example in which the user inputs a character through the operation unit 212 of the information processing apparatus 101 has been described in the above exemplary embodiments, an exemplary embodiment can also be applied in a case in which the user inputs a character through an operation unit of the printer 103. The operation unit of the printer 103 includes a touch panel formed integrally by a touch panel sheet and a liquid crystal display unit, and displays a software keyboard on the touch panel to accept input of characters from the user. The software keyboard can accept input of alphabets, symbols, and Hiragana characters, and the input Hiragana characters can be converted into Chinese characters or Katakana characters. Furthermore, the exemplary embodiments described above can also be applied to a case in which the user inputs a character through an operation unit of a portable terminal.

In addition, although the exemplary embodiments above have been described under the assumption that the information processing apparatus 101 is a PC, the information processing apparatus 101 may be a mobile phone. In the case in which the information processing apparatus 101 is a mobile phone, in place of a keyboard and a mouse, a keyboard or a touch panel affixed to the display unit 213 may be used as the operation unit 212.

The functions indicated in the flowcharts in the exemplary embodiments can also be realized by a processing device (CPU, processor) of a computer or the like executing software (program) obtained through a network or various storage media.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims the benefit of Japanese Patent Application No. 2013-020323 filed Feb. 5, 2013, which is hereby incorporated by reference herein in its entirety.

What is claimed is:

1. An information processing apparatus, comprising:
a storage unit configured to store an input character string as an input history;
a display unit configured to display a character string that follows a character input by a user as an input candidate based on the input history stored in the storage unit;
a registration unit configured to register a predetermined character string;
a control unit configured to control such that the predetermined character string registered in the registration unit is not displayed as the input candidate;
a deletion unit configured to delete a character string from the input history stored in the storage unit;
a retaining unit configured to retain a value corresponding to the number of times the character string has been deleted by the deletion unit; and
a determination unit configured to determine whether the value retained by the retaining unit is equal to or greater than a predetermined value,
wherein the registration unit registers the character string deleted by the deletion unit if the determination unit determines that the value retained by the retaining unit is equal to or greater than the predetermined value.

2. The information processing apparatus according to claim 1, further comprising:
a modification unit configured to modify the predetermined value in accordance with an instruction from the user.

3. The information processing apparatus according to claim 1, wherein the control unit controls such that the predetermined character string registered in the registration unit is not stored in the storage unit as the input history.

4. The information processing apparatus according to claim 1, wherein the character string is an address.

5. An information processing apparatus, comprising:
a storage unit configured to store an input character string as an input history;
a display unit configured to display a character string that follows a character input by a user as an input candidate based on the input history stored in the storage unit; and
a control unit configured to control such that the input character string is stored in the storage unit if user authentication by the input character string has been successful, or to control such that the input character string is not stored in the storage unit if user authentication by the input character string has not been successful.

6. The information processing apparatus according to claim 5, wherein the character string is a user name.

7. A method for controlling an information processing apparatus, the method comprising:
storing an input character string as an input history;
displaying a character string that follows a character input by a user as an input candidate based on the input history stored in the storage unit; and
controlling such that the input character string is stored in the storage unit if user authentication by the input character string has been successful, or such that the input character string is not stored in the storage unit if user authentication by the input character string has not been successful.

8. A storage medium storing a computer program for causing a computer to implement a method for controlling an information processing apparatus, the computer program comprising:
a code for storing an input character string as an input history;
a code for displaying a character string that follows a character input by a user as an input candidate based on the input history stored in the storage unit; and
a code for controlling such that the input character string is stored in the storage unit if user authentication by the input character string has been successful, or such that the input character string is not stored in the storage unit if user authentication by the input character string has not been successful.
